(19) United States
(12) Patent Application Publication
(10) Pub. No.: US 2013/0181371 A1
(43) Pub. Date: Jul. 18, 2013

(54) X-RAY DETECTABLE PLASTICS

(71) Applicant: Timothy C. Brown, Gastonia, NC (US)

(72) Inventor: Timothy C. Brown, Gastonia, NC (US)

(21) Appl. No.: 13/743,907

(22) Filed: Jan. 17, 2013

Related U.S. Application Data
(60) Provisional application No. 61/587,187, filed on Jan. 17, 2012.

(51) Int. Cl. B29C 67/00

(52) U.S. Cl. CPC B29C 67/0044
USPC 264/162

(57) ABSTRACT

Extrusion and compression molding methods for making X-ray detectable, resin-based material in stock shapes such as rods and sheets. The rods and sheets include barium sulfate in a concentration such that the structural properties of the resin are not materially altered from those of pure resin, but relatively small fragments of the material are X-ray detectable by conventional equipment, even at high line speeds.

### BACKGROUND OF THE INVENTION

1. Field of the Invention

The subject invention concerns methods for making materials and, in particular, methods for making materials that can be used for machines in the food processing and pharmaceutical industries.

2. Discussion of the Prior Art

Repeated handling, cleaning, and normal wear and tear of plastic component parts, such as those on food, beverage, and pharmaceutical processing machinery, creates a risk that fragments of the components may break off and contaminate the product that is being processed. The difficulty and risk of such parts going undetected tends to increase as the production line speed also increases. This is of special concern in the food-processing and pharmaceutical industries where broken machine fragments that contaminate food and medications for human consumption could go undetected. Indeed, Food and Drug Administration regulations require that all food processors have comprehensive preventive controls and safety programs to avoid such contamination.

Many food-processors perform quality checks at selected control points, typically with either metal detection systems, X-ray detection systems, or both. In many cases, X-ray systems are required or preferred because they are more effective and because X-ray systems can effectively detect contamination even after the food has been packaged.

In the prior art, it has been known to use resin-based materials in the construction of food-processing and pharmaceutical machinery. Such materials are particularly useful in that they are light, durable and do not corrode in the way of metals and certain other materials. However, one disadvantage of using such materials in the construction of food-processing and pharmaceutical machinery has been that such materials are relatively difficult to detect in the event that they become intermixed with the food or pharmaceutical product due to wear or failure of the machine parts. Accordingly, there has been a need in the prior art for machine parts that could be made from a resin-based composition and that were better suited for use in the food processing and pharmaceutical industries.

In some cases, the suitability of resin-based materials for use in the food-processing and pharmaceutical industries has been improved by the use of resin-based materials that are X-ray detectable. However, there have been shortcomings and difficulties in the use of those materials. Essentially, that is because such materials were used only in connection with injection molding techniques.

Injection molding processes are advantageous in that they can form parts in specific shapes without substantial machining. However, injection molding processes are unsuitable for many applications because they are limited in the size of parts and the shape of parts that can be formed. Many parts and components that are used in food-processing and other industries are too large to be conveniently or cost-effectively injection molded. Those parts are best made by machining the part from stock shapes.

Accordingly, there was a need in the prior art for a method of making machining stock from a resin-based composition that is X-ray detectable. Such stock would be highly useful and fill a need in the prior art for making parts and components that are used in various filling, sorting, and packaging machinery.

### SUMMARY OF THE INVENTION

In accordance with the presently disclosed invention, a method for machining parts from resin-based stock includes the steps of compounding barium sulfate and a base resin. The base resin is selected from the group of acetal, polyether ether ketone (“PEEK”), and ultra-high molecular weight polyethylene (“UHMW-PE”). The molecular weight of such UHMW-PE is 3-6 million. A color pigment also can be added. In some cases, the base resin, barium sulfate and pigment (if present) are formed into homogenous pellets that are fed to an extrusion machine. The extrusion machine melts the homogenous pellets into a fluid mass and extrudes the mass through a die to provide an extrusion of a defined outer shape such as a rod or a sheet. The extruded shapes are cut to length and then annealed to form stock from which parts can be machined.

Preferably, the barium sulfate is used in the amount of 10% to 20% by weight. More preferably, barium sulfate is used in the amount of 12% to 18% by weight; and, most preferably, 14% to 16% by weight. It has been found that if barium sulphate is used at higher concentrations, physical properties of the base resin are affected so as to impair tensile strength and cause embrittlement that can result in breakage and cracking. If barium sulphate is used at lower concentrations, the x-ray detectability is insufficient for conventional x-ray detection devices to identify sufficiently small fragments (down to three cubic millimeters) at appropriate production line speeds (up to 250 feet per minute).

To form a sheet of machining stock of ultra-high molecular weight polyethylene resin, barium sulfate powder is combined with ultra-high molecular weight polyethylene powder having 3-6 million molecular weight in a homogeneous mixture. A color pigment can also be added to the mixture. The homogenous mixture is then placed in the mold of a compression molding machine to a predetermined depth according to the desired thickness of the sheet. The compound is then heated at a controlled rate and under a controlled pressure profile, held at a specific temperature and pressure according to the thickness of the compound, and then the heated compound is allowed to cool at a controlled rate and under a controlled pressure. The sheet of cooled stock material is then removed from the mold.

Also preferably, the concentration of the barium sulfate is such that a piece of extruded or compression molded stock that is of a size of at least 3 cubic millimeters and that is moving at a velocity of up to 250 feet per minute relative to a commercially available X-ray detection device such as typically used in the food-processing and pharmaceutical industries is detectable by such device.

Other objects and advantages of the presently disclosed invention will become apparent to those skilled in the art as a description of presently preferred embodiments of the invention proceeds.

### DESCRIPTION OF PRESENTLY PREFERRED EMBODIMENTS OF THE INVENTION

The presently preferred embodiments of the presently disclosed invention relate to X-ray detectable forms of resins, such as, for example and without limitation, ultra-high molecular weight polyethylene (UHMW-PE), acetal, and polyether ether ketone (PEEK). The X-ray detectable plastics are comprised a plastic resin, such as acetal resin, PEEK resin, and UHMW-PE (3-6 million molecular weight) resin, in combination with 10% to 20% by weight barium sulfate. Preferably, barium sulfate can be used in amounts of 12% to 18% by weight and, more preferably, in amounts of 14% to 16% by weight of barium sulfate. Most preferably, about 15% by weight barium sulfate is used. Barium sulfate is an agent that, when mixed in sufficient concentration with the resin, makes the compound detectable by conventional X-ray inspection techniques such as those that are currently used in industrial processes.

According to the disclosed invention, such X-ray detectable plastics are manufactured into stock shapes such as, for example and without limitation, sheets and rods by compression molding and extrusion processes. In an example, rods about 0.5 inch to about 6 inches in diameter and sheets about 0.375 inch to about 4 inches thick were manufactured. The large stock shapes are readily and cost-effectively be machined into parts and components of specific shapes. Since they are made of X-ray detectable stock, such parts and components are especially useful in the food-processing and pharmaceutical industries.

In the case of extrusion processes, resin-based stock that is useful to make parts that are especially adapted to use in food-processing and pharmaceutical machinery is made by compounding homogenous pellets of barium sulfate and a base resin. To form extruded rods, the base resin is selected from the group comprising acetal, PEEK, or ultra-high molecular weight polyethylene resins. To form extruded sheets, the base resin is selected from the group comprising acetal and PEEK resins. If desired, a color pigment also can be added to the homogeneous pellets. In the food-processing industry, the color blue is often preferred because it affords easier visual discrimination from most food and pharmaceutical products.

Pellets formed of homogenous blend of acetal resin or PEEK resin in combination with amounts of barium sulfate as specified herein are fed to a screw-type extrusion machine in the normal manner as is well-known and understood by those skilled in the art. Within the extruder, the heat and pressure applied to the resin-based pellets liquefies the pellets into a fluid mass that is forced through a die. The die defines the external cross-sectional shape for the extruded material. In the case of extruded rods the cross-sectional shape is circular and in the case of sheets, the cross-sectional shape is rectangular—all as well known and understood by those skilled in the art.

Thereafter, the extruded shapes are cut to length and annealed to relieve internal stresses in the extruded material—also as known and practiced by those skilled in the art. The extruded, annealed shape can then be machined to form a part or component that is suitable for use in the particular machine to which it is applied.

In the case of compression molded processes, resin-based sheet stock that is useful in making parts that are especially adapted to use in the food-processing and pharmaceutical machinery is made by forming a homogenous mixture of barium sulfate powder and ultra-high molecular weight polyethylene resin powder (3-6 million molecular weight). If a color is desired, an appropriate color pigment is also added. In the process, the powdered mixture is placed in the mold of a conventional compression molding machine.

To produce sheets, the mold is generally in the form of a rectangular slab as known to those skilled in the art. As also known, the powdered compound is placed in the mold to a depth in accordance with the desired thickness of the molded sheet. The mold is then closed and standard temperature and pressure profiles are executed on the mold—again as known to those skilled in the art. Those profiles cause the temperature and pressure within the mold to rise in a controlled manner according to specified rates. The pressure and temperature are thereafter maintained for specific hold times according to the type and thickness of the resin and thereafter the temperature and pressure are reduced under controlled conditions. At the end of the mold cycle, the compression mold is opened and the machineable compound sheet is removed from the mold. Thereafter, the sheet stock can be machined to given shape for use in a particular processing machine.

Again, the temperature and pressure profiles, hold times and other variables that are used are known in the art except that the use of barium sulfate in the concentrations and amounts disclosed herein were not known in the prior art. The use of barium sulfate in such amounts and concentrations to make stock materials such as rods and sheets as herein disclosed produces a machineable stock material that is highly detectable by conventional X-ray techniques and at relatively high production line speeds of up to 250 feet per minute.

Compounds of UHMW-PE with 15% barium sulfate and acetal resin with 15% barium sulfate have been manufactured according to extrusion processes and compression molding processes to provide compounds in stock shapes such as rods and sheets that can be machined into relatively large, X-ray detectable parts. Fragments of such stock materials as small as about 3 cubic millimeters and larger and moving at a velocity relative to the X-ray detection machine of as fast as 250 feet-per-minute were detected by conventional X-ray detection equipment such as is normally found in commercial use. Typically, X-ray detected plastic products are detected and automatically sorted to a product hold area for further inspection and determination.

X-ray detectable plastics as herein disclosed can be used with various types of packaging, including, for example and without limitation, metal cans, plastic, composite containers, and glass jars. In further embodiments, the X-ray detectable plastics may be used in applications such as, for example and without limitation, scraper blades, filler plates, pocket fillers, piston fillers, mixer components, wear plates, volumetric fillers, hopper guides, baffles, pillow blocks, cups and sleeves, dividers, as well as other uses.

The X-ray detectable plastics disclosed herein provide a detection function with X-ray systems. Such a detection system is especially useful in the food processing and pharmaceutical industries to reduce or limit the risk of a plastic part contaminating the food or pharmaceutical product.

While several embodiments of the invention have been described, it is apparent that various modifications, alterations and adaptations to those embodiments may occur to persons skilled in the art with the attainment of some or all of the advantages of the presently disclosed invention. It is therefore intended to cover all such modifications, alterations and adaptations without departing from the scope and spirit of the present invention.

I claim:

1.) A method for making resin-based parts for use in a processing machine, said method comprising the steps of:
compounding barium sulfate, a color pigment and a base resin from the group comprising acetal or PEEK into pellets;
feeding said pellets into a screw extrusion machine to form a compound;
extruding the compound through a die to form an extruded shape;
annealing the extruded shape; and
machining the annealed, extruded shapes to form a part.

2.) The method of claim 1 wherein the pellets in said compounding step include 10% to 20% by weight of barium sulfate.

3.) The method of claim 1 wherein the pellets in said compounding step include 12% to 18% by weight of barium sulfate.

4.) The method of claim 1 wherein the pellets in said compounding step include 14% to 16% by weight of barium sulfate.

5.) The method of claim 4 wherein said color pigment is blue.

6.) The method of claim 4 wherein said extruded shape is in the form of one of a rod or a sheet.

7.) A method for making resin-based parts for use in a processing machine, said method comprising the steps of:
compounding barium sulfate, a color pigment and ultra-high molecular weight polyethylene into a powder;
placing said powdered compound in a mold of a compression molding machine;
closing the mold of the compression molding machine;
heating the powdered compound at a controlled rate and under a controlled pressure;
holding the compound in the mold at a given temperature and pressure according to the thickness of the compound;
cooling the heated compound at a controlled rate and under a controlled pressure;
removing the sheet of cooled material from the mold; and
machining the sheet of material to form a part.

8.) The method of claim 7 wherein the pellets in said compounding step include 10% to 20% by weight of barium sulfate.

9.) The method of claim 7 wherein the pellets in said compounding step include 12% to 18% by weight of barium sulfate.

10.) The method of claim 7 wherein the pellets in said compounding step include 14% to 16% by weight of barium sulfate.

11.) The method of claim 10 wherein said color pigment is blue.

12.) The method of claim 10 wherein said extruded shape is in the form of one of a rod or a sheet.

13.) A method for making a part from stock made of a resin-based composition, where a piece of said stock having a size of at least 3 cubic millimeters and moving at a velocity of up to 250 feet per minute relative to an X-ray detection device is detectable by such device, said method comprising the steps of:
compounding a color pigment, a base resin selected from the group of resins comprising acetal or PEEK, and 10% to 20% by weight of barium sulfate into pellets;
feeding said pellets into a screw extrusion machine to form a compound;
extruding the compound through a die to form an extruded shape;
annealing the extruded shape; and
machining the annealed, extruded shape to form a part.

14.) The method of claim 13 wherein the pellets in said compounding step include 12% to 18% by weight of barium sulfate.

15.) The method of claim 13 wherein the pellets in said compounding step include 14% to 16% by weight of barium sulfate.

16.) The method of claim 15 wherein said color pigment is blue.

17.) The method of claim 15 wherein said extruded shape is in the form of one of a rod or a sheet.

18.) A method for making a part from stock made of a resin-based composition, where a piece of said stock having a size of at least 3 cubic millimeters and moving at a velocity of up to 250 feet per minute relative to an X-ray detection device is detectable by such device, said method comprising the steps of:
compounding, a color pigment, ultra-high molecular weight polyethylene, and barium sulfate in 10% to 20% by weight into a homogenously mixed powder;
placing a quantity of said homogenous powdered compound in the mold of a compression molding machine to form a layer of said compound of predetermined depth;
heating the powdered compound in the mold at a controlled rate and under a controlled pressure;
holding the compound in the mold at a given temperature and pressure according to the thickness of the compound;
cooling the heated compound in the mold at a controlled rate and under a controlled pressure;
removing the cooled compound from the mold; and
machining the sheet of material to form a part.

19.) The method of claim 18 wherein the pellets in said compounding step include 12% to 18% by weight of barium sulfate.

20. The method of claim 18 wherein the pellets in said compounding step include 14% to 16% by weight of barium sulfate.
